(19) United States
(12) Patent Application Publication
(10) Pub. No.: US 2020/0364725 A1
(43) Pub. Date: Nov. 19, 2020

(54) REGULATORY CATEGORY ASSIGNMENT VIA MACHINE LEARNING

(71) Applicant: SAP SE, Walldorf (DE)

(72) Inventors: Johannes Hoehne, Berlin (DE); Rohit Kumar Gupta, Heidelberg (DE); Volker Loch, Walldorf (DE); Julian Stoettinger, Heidelberg (DE)

(21) Appl. No.: 16/413,101

(22) Filed: May 15, 2019

(51) Int. Cl. G06Q 30/00; G06N 20/00; G06Q 50/26

(52) U.S. Cl. CPC G06Q 30/018; G06Q 50/265; G06N 20/00

(57) ABSTRACT

Provided is a system and method that can assign a product to a regulatory group via a machine learning algorithm. The system can predict whether a product belongs in any of a number of different groups and retrieve regulations for the predicted groups. In one example, the method may include receiving an alphanumeric identifier of an object, predicting that the object is included within one or more regulatory categories via execution of a regulatory-based machine learning algorithm that receives the identifier of the object as an input and classifies the object into the one or more regulatory categories, retrieving regulation information about the one or more predicted regulatory categories for at least one jurisdiction associated with the object, and outputting the retrieved regulation information about the one or more predicted regulations for display via a user interface.

### BACKGROUND

Product compliance requires discrete manufacturers to comply with product-related environmental regulations such as the European Directive for the Restriction of Hazardous Substances (EU RoHS) and the Registration, Evaluation, Authorization and Restriction of Chemicals (REACH) which includes Substances of Very High Concern (REACH SVHC). For the automotive industry, collaboration and electronic data exchange over the IMDS (International Material Data System) is enforced. These regulations comprise laws which states that certain types of substances that can be hazardous if not properly managed shall not be manufactured or sold unless they have been registered in accordance with the relevant provisions therein. Failure to comply with these regulations can lead to pressures such as penalties/fines and even imprisonment.

Due to the severe consequence that can occur from failed or mistaken compliance, a compliance expert typically reviews a product and determines whether the product falls within a regulatory group (e.g., benzene, lead, mercury, methanol, phthalates, etc.) This requires the expert user to manually read the ingredients and identify which regulations are relevant. Each ingredient may fall within multiple different regulations, and each product may include many (e.g., dozens or even hundreds) of ingredients. Therefore, the process of regulatory compliance can be time-consuming with no room for error. Also, experts are limited in number. Accordingly, what is needed is an improved mechanism for product compliance.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a database system architecture in accordance with an example embodiment.

FIG. 2A is a diagram illustrating a process of searching for regulatory information of a product in accordance with an example embodiment.

FIG. 2B is a diagram illustrating an example of products being assigned to regulatory categories through machine learning in accordance with an example embodiment.

FIG. 3 is a diagram illustrating a user interface outputting regulatory information in accordance with an example embodiment.

FIG. 4 is a diagram illustrating an example of a machine learning model for assigning products to regulatory categories in accordance with an example embodiment.

FIG. 5 is a diagram illustrating a method of assigning a product to one or more regulatory categories in accordance with an example embodiment.

FIG. 6 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

For manufacturers, the products that they develop often have various compliance requirements that must be fulfilled. The compliance requirements may differ depending on factors such as regulations that depend on the sales area, regulations that depend on the area of production, regulations that depend on the industry or product category, industry group requirements, customer requirements, and the like. Some of the predominant regulations and requirements include the EU RoHS, the REACH SVT, China RoHS, IMDS Recommendations and the like. These requirements for products may in turn demand requirements for components and basic materials of the salable product. In order to fulfill a requirement, the focused material must meet a number of conditions. A check may be performed to determine which conditions are met and which are not.

A product (such as an ingredient in the product) may be subject to multiple regulations. Therefore, each ingredient may be evaluated. Furthermore, compliance requirements may be different among different jurisdictions. Therefore, a product that is being produced/distributed in Europe may have different regulations than a product being produced/distributed in China.

Regulatory lists, regulatory list revisions, compliance requirements, and compliance requirement revisions are central to the area of product compliance. In regulatory list management, a company may define several regulatory lists, such as Restriction of Hazardous Substances (RoHS 2002/95/EG), REACH Substance of Very High Concern (REACH SVHC), and the like. Each of these lists defines listed substances or groups of substances that are prohibited or regulated to be declared. These regulatory lists are public regulations, which are valid for the defined regions. In addition, companies may define their own regulated substance lists, whose requirements must be met by their companies' suppliers. Customers often request additional reports or declarations. One listed substance can be regulated in multiple regulatory list revisions at the same time. A substance can be regulated using its listed substance name in one regulation and a listed substance group in another regulation.

Some regulations define exemptions for certain usages. For a certain usage of a listed substance, a higher threshold, or even no threshold (unlimited), may be defined. Over time these exemptions may expire which cannot be used anymore. These exemptions are usually proposed by the industry groups and agreed by the authority of the regulation. Furthermore, revisions are not static but evolve over time. The number of listed substances may increase, exemptions could be assigned to substances, old exemptions may expire, and the allowed threshold may decrease. Therefore, a substance that had formerly been declarable may be prohibited in the new revision. Usually, the revisions of regulatory substance lists are published in waves.

A compliance requirement is the information that describes the state of compliance of a material that has been assigned to a specific regulation. A compliance requirement often has a name similar to the corresponding regulatory list. Compliance requirements can have several revisions of their own even if they belong to the same regulatory list revision. Only one compliance requirement revision can be active (released) at one time. One can be in process (inactive), and all others are historic.

At present there are over 100 million different chemical substances that can be included in a product. Given this amount of information, a regulatory assignment is typically performed by a human (compliance expert). These experts are very busy and are limited in number. Furthermore, these experts can be expensive resulting in a greater cost of the transport that is ultimately passed down to the consumer. Experts must also have a very detailed knowledge of the rules and regulations of different national/international compliance requirements. This can require significant expertise and also a continuing education of the evolving rules and regulations. Furthermore, expert decisions have little room for error because mistakes can result in penalties such as fines and even imprisonment.

The example embodiments provide a system which can automatically predict a regulatory assignment of a product into one or more regulatory groups (categories). The system may receive an identifier (chemical name, substance trade name, ingredient, etc.) of a product and input the identifier into a machine learning algorithm configured to predict whether the product falls within a plurality of different regulatory groups. There can be dozens, hundreds, or more different regulatory groups. Each of these groups may be referred to as regulatory “categories” and each may have their own regulations associated therewith. The machine learning algorithm may perform a text-based (or character-based) classification based on the identifier. The machine learning algorithm may identify sequences of small character segments (e.g., 1-3 characters, etc.) which can have the greatest impact on the regulatory group assignment, and classify the product into one or more regulatory groups based thereon. In addition to predicting which regulatory group(s) the product should be categorized into, the system may also output regulations from multiple jurisdictions (international) as a search result.

The system described herein may be embodied as a service, an application, a program, or the like, which is hosted by a central computing system such as a database, a cloud platform, a web server, or the like. As another example, the system may be implemented locally on a user device, an on-premises server, etc. In either scenario, the system may evolve to address changes in regulations over time. For example, software updates may be provided to modify any regulations, add new regulations, delete regulations, and the like. This prevents a user from having to continuously monitor all revisions to regulations. The system may be used to provide an automated group assignment that replaces an expert, or that supplements the expert's opinion thereby improving the accuracy and decreasing the amount of time spent by the expert in evaluating the group assignment of a product.

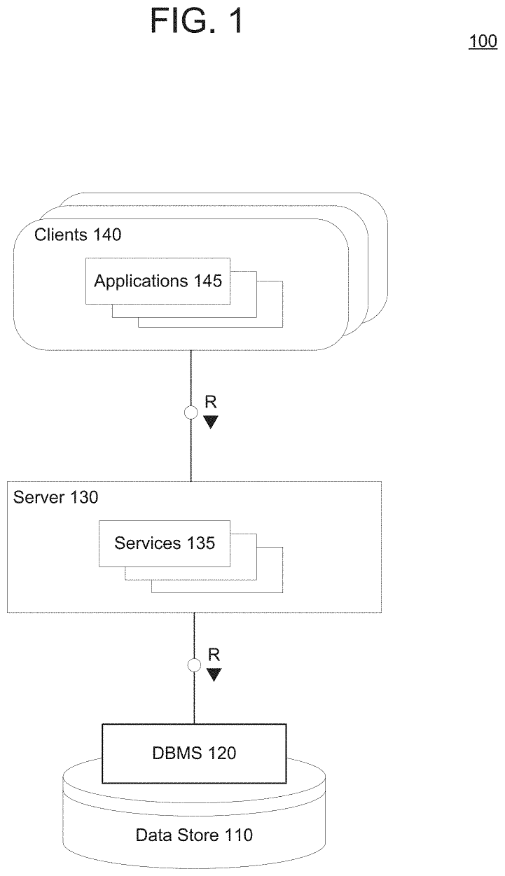

FIG. 1 illustrates a system architecture of a database 100 in accordance with an example embodiment. It should be appreciated that the embodiments are not limited to architecture 100 or to a database architecture, however, FIG. 1 is shown for purposes of example. Referring to FIG. 1, the architecture 100 includes a data store 110, a database management system (DBMS) 120, a server 130, services 135, clients 140, and applications 145. Generally, services 135 executing within server 130 receive requests from applications 145 executing on clients 140 and provides results to the applications 145 based on data stored within data store 110. For example, server 130 may execute and provide services 135 to applications 145. Services 135 may comprise server-side executable program code (e.g., compiled code, scripts, etc.) which provide functionality to applications 145 by providing user interfaces to clients 140, receiving requests from applications 145 (e.g., drag-and-drop operations), retrieving data from data store 110 based on the requests, processing the data received from data store 110, and providing the processed data to applications 145.

In one non-limiting example, a client 140 may execute an application 145 to perform an automated regulatory group assignment via a machine learning model. In this example, the user interface may display, to the client 140, predicted regulatory groups and regulations of a product being searched. The regulations may be from a plurality of jurisdictions giving the user an international understanding of the product compliance requirements. In some embodiments, the application 145 may output a confidence of the predicted regulatory assignment and regulation information. The application 145 may pass requests to one of services 135 based on input received via the client 140. A structured query language (SQL) query may be generated based on the request and forwarded to DBMS 120. DBMS 120 may execute the SQL query to return a result set based on data of data store 110, and the application 145 creates a report/visualization based on the result set.

The services 135 executing on server 130 may communicate with DBMS 120 using database management interfaces such as, but not limited to, Open Database Connectivity (ODBC) and Java Database Connectivity (JDBC) interfaces. These types of services 135 may use SQL and SQL script to manage and query data stored in data store 110. The DBMS 120 serves requests to query, retrieve, create, modify (update), and/or delete data from database files stored in data store 110, and also performs administrative and management functions. Such functions may include snapshot and backup management, indexing, optimization, garbage collection, and/or any other database functions that are or become known.

Server 130 may be separated from or closely integrated with DBMS 120. A closely-integrated server 130 may enable execution of services 135 completely on the database platform, without the need for an additional server. For example, server 130 may provide a comprehensive set of embedded services which provide end-to-end support for Web-based applications. The services 135 may include a lightweight web server, configurable support for Open Data Protocol, server-side JavaScript execution and access to SQL and SQLScript. Server 130 may provide application services (e.g., via functional libraries) using services 135 that manage and query the database files stored in the data store 110. The application services can be used to expose the database data model, with its tables, views and database procedures, to clients 140. In addition to exposing the data model, server 130 may host system services such as a search service, and the like.

Data store 110 may be any query-responsive data source or sources that are or become known, including but not limited to a SQL relational database management system. Data store 110 may include or otherwise be associated with a relational database, a multi-dimensional database, an Extensible Markup Language (XML) document, or any other data storage system that stores structured and/or unstructured data. The data of data store 110 may be distributed among several relational databases, dimensional databases, and/or other data sources. Embodiments are not limited to any number or types of data sources.

In some embodiments, the data of data store 110 may include files having one or more of conventional tabular data, row-based data, column-based data, object-based data, and the like. According to various aspects, the files may be database tables storing data sets. Moreover, the data may be indexed and/or selectively replicated in an index to allow fast searching and retrieval thereof. Data store 110 may support multi-tenancy to separately support multiple unrelated clients by providing multiple logical database systems which are programmatically isolated from one another. Furthermore, data store 110 may support multiple users that are associated with the same client and that share access to common database files stored in the data store 110.

According to various embodiments, data items (e.g., data records, data entries, etc.) may be stored, modified, deleted, and the like, within the data store 110. As an example, data items may be created, written, modified, or deleted based on instructions from any of the applications 145, the services 135, and the like. Each data item may be assigned a globally unique identifier (GUID) by an operating system, or other program of the database 100. The GUID is used to uniquely identify that data item from among all other data items stored within the database 100. GUIDs may be created in multiple ways including, but not limited to, random, time-based, hardware-based, content-based, a combination thereof, and the like.

The architecture 100 may include metadata defining objects which are mapped to logical entities of data store 110. The metadata may be stored in data store 110 and/or a separate repository (not shown). The metadata may include information regarding dimension names (e.g., country, year, product, etc.), dimension hierarchies (e.g., country, state, city, etc.), measure names (e.g., profit, units, sales, etc.) and any other suitable metadata. According to some embodiments, the metadata includes information associating users, queries, query patterns and visualizations. The information may be collected during operation of system and may be used to determine a visualization to present in response to a received query, and based on the query and the user from whom the query was received.

Each of clients 140 may include one or more devices executing program code of an application 145 for presenting user interfaces to allow interaction with application server 130. The user interfaces of applications 145 may comprise user interfaces suited for reporting, data analysis, and/or any other functions based on the data of data store 110. Presentation of a user interface may include any degree or type of rendering, depending on the type of user interface code generated by server 130. For example, a client 140 may execute a Web Browser to request and receive a Web page (e.g., in HTML format) from application server 130 via HTTP, HTTPS, and/or WebSocket, and may render and present the Web page according to known protocols.

One or more of clients 140 may also or alternatively present user interfaces by executing a standalone executable file (e.g., an .exe file) or code (e.g., a JAVA applet) within a virtual machine. Clients 140 may execute applications 145 which perform merge operations of underlying data files stored in data store 110. Furthermore, clients 140 may execute the conflict resolution methods and processes described herein to resolve data conflicts between different versions of a data file stored in the data store 110. A user interface may be used to display underlying data records, and the like.

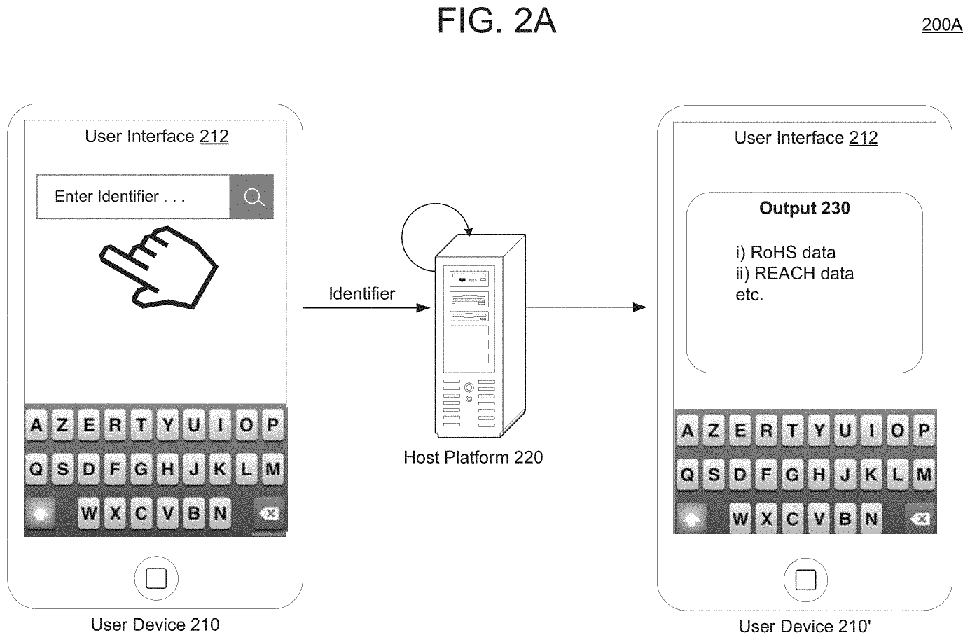

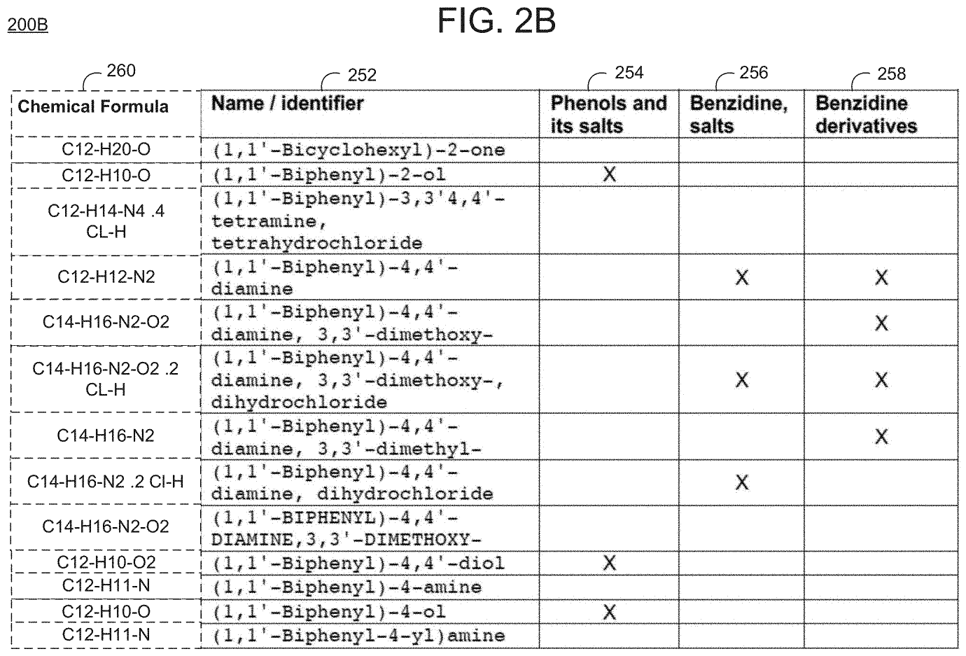

FIG. 2A illustrates a process 200A of searching for regulatory information of a product in accordance with an example embodiment. Meanwhile, FIG. 2B illustrates a process 200B of products being assigned to regulatory categories through machine learning in accordance with an example embodiment. The process 200B performed in FIG. 2B may be included within the search process 200A of FIG. 2A, however, embodiments are not limited thereto. Referring to FIG. 2A, a user device 210 may display a user interface 212 that enables a user to enter a product identifier. Furthermore, the user device 210 may submit the product identifier to a host platform 220 to search for regulatory information of a product associated with the product identifier. In this example, the user device 210 may be connected to the host platform 220 via the Internet, but embodiments are not limited thereto. As another example, the search may be performed locally by the user device 210 (without the host platform 220).

The product identifier may be an alphanumeric string including numbers and/or letters describing information about the product. For example, the identifier may include an attribute of the product such as a chemical name, a substance name, a compound, an ingredient, etc. As another example, the identifier may include a plurality of attributes that can be searched at the same time. In some embodiments, the product identifier may include a chemical name such as a trade name of an ingredient within the product, or the like.

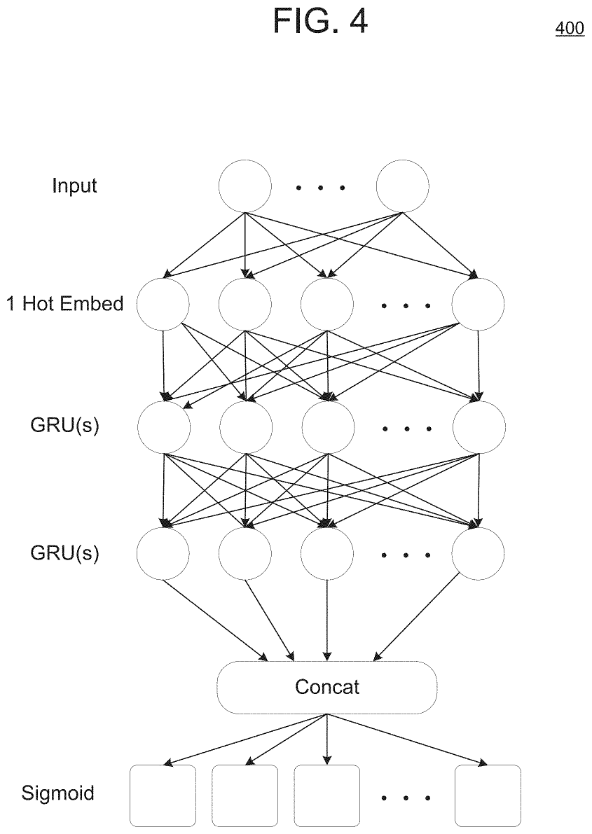

In response to receiving the product identifier, the host platform 220 may execute a machine learning algorithm, for example, as shown in the example of FIG. 4. The machine learning algorithm may be a deep learning neural network, a convolutional neural network, or the like. The type of machine learning algorithm is not limited to any particular kind, but may be performed by different types of algorithm. Here, the machine learning algorithm may receive the identifier and detect small sub-strings or segments within the identifier through various mechanisms such as one-hot encoding, etc. Based on the identified sub-strings, and the sequence in which the sub-strings occur, the machine learning algorithm may predict whether the product falls into one or more regulatory categories.

Referring now to FIG. 2B, a process 200B is performed to determine whether a plurality of identifiers 252 fall within any of the three categories 254, 256, and 258 which correspond to Phenols and its salts, Benzidine salts, and Benzidine derivatives, respectively. Although these groups are very similar, compliance for each group is different (different regulations). Also shown for convenience is the chemical formulas 260 for each of the identifiers 252. As shown in the example of FIG. 2B, a small change in sequence and/or chemical formula can result in the identifier 252 ending up in a different regulatory category 254, 256, or 258. In some cases, an identifier is not predicted to be included in any of the three categories 254, 256, or 258, while in other cases, an identifier 252 is predicted to be in one or more categories 254, 256, and 258. An example of the machine learning model is shown in FIG. 4.

One example in FIG. 2B is item 262 ((1,1′-Biphenyl)-3,3′4,4′-tetramine, tetrahydrochloride). In this example, the item 262 is not categorized as Benzidine, although multiple word-components (i.e. Biphenyl, amine) are associated with Benzidine. This is one example that shows how the machine learning model can help the experts to be more productive. Note that the chemical formula 260 is not used by the ML model, it is just shown to improve the readability for experts.

Returning now to FIG. 2A, after the machine learning algorithm has determined a regulatory category or categories for the identifier, the host platform 220 may generate and output information 230 about regulations that are associated with the respective regulatory category or categories to the user device 210′. In this case, the user device 210 and the user device 210′ may be the same device but before and after the search. The regulations may be from multiple jurisdictions (not just one jurisdiction) thereby simplifying the process for a user. The resulting output 230 may be used to supplement a process of regulatory categorization performed by an expert.

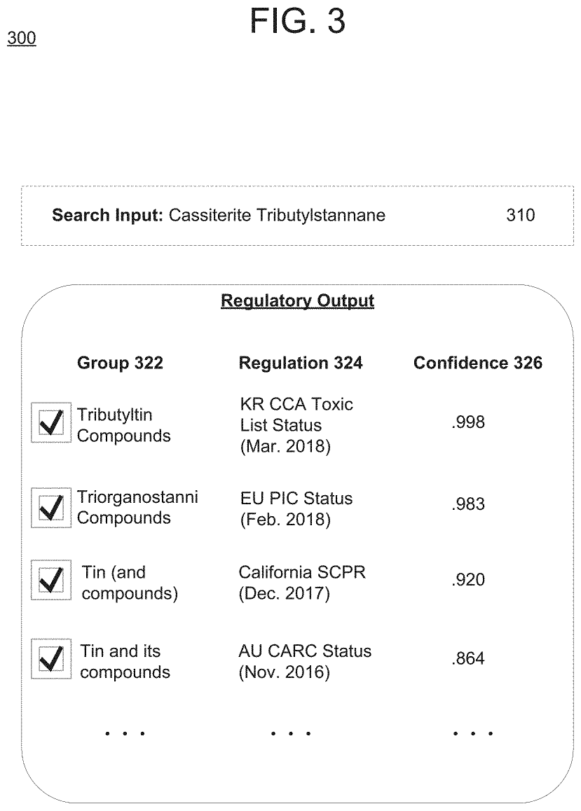

FIG. 3 illustrates an example of a user interface outputting regulatory information in accordance with an example embodiment. For example, the user interface 300 may be what is displayed as the output 230 on the user device 210′ shown in FIG. 2A. In the example of FIG. 3, the identifier 310 being searched is “Cassiterite Tributylstannane.” In response, the machine learning algorithm identifies different groups 322 (categories) that the product falls within based on the identifier 310 being searched.

In this example, each result also includes a list of regulatory information 324, and a confidence value 326. The regulatory information may identify a jurisdiction (e.g., country, union, state, etc.) as well as the name of the regulation(s), a time at which the regulation(s) was enacted, and the like. Furthermore, the predictive algorithm may determine a probability (e.g., between 0 and 1) of whether a product belongs in a group 322 based on the predictive algorithm. This probability may be used to determine the confidence value 326 for the respective group 322 being predicted as an assignment.

In this example, the input 310 may be a trade name or description of an ingredient within the product such as a chemical or a substance. The system may receive this input and output a list of laws (KR, US, European, China, etc.). The input 310 may be chosen by the user based on any desired search criteria and the system finds the attributes to output. In this case, the input 310 is also referred to as a search key which is a chemical term or chemical name which describes the product. There can be several naming conventions for the same chemical. But the system can identify them as the same possible trade name and find the regulations associated therewith. The machine learning algorithm implicitly learns a lot of things that only experts know. So if you have a product name that applies to one of the regulations and you have another product name that is similar but includes an additional variable the system can learn that this product may be even more dangerous, etc.

The model can discern between identifiers that are very similar in name, but different in sequence, small changed to a chemical attribute, etc. which can cause a drastically different regulatory category assignment. These groups/categories 322 shown in FIG. 3 may be hard coded into the machine learning algorithm as labels and the machine learning algorithm may classify each identifier into one or more labels (or no labels). These groups/categories can be modified. But the model is not adapting to the user input over time. As an example, there may be hundreds of different regulatory groups 322.

FIG. 4 illustrates an example of a machine learning model 400 for assigning products to regulatory categories in accordance with an example embodiment. The machine learning model 400 can be trained on historical product classifications (e.g., identifiers and their resulting classification into one or more groups/labels). In this way, the machine learning model 400 may receive as input a composition that it has never seen before, however, there may be enough of a pattern within the identifier that the algorithm can predict which category or categories the product should be assigned to. The input is a sequence of characters (letters and numbers) and both can play a role in the group categorization. A location of a number in a different spot can cause a different group assignment. The model learns chemical knowledge. For example, Tetramine is not regulated (not dangerous) but diamine is heavily regulated and really dangerous. The machine learning model can learn these differences. That is, the model identifies patterns among the sequences in the wording of the name. Identification of a specific segment may be used by the model, as well as what comes before and after the specific segment.

As shown in FIG. 4, the model 400 includes a multi-layer deep learning neural network, however, embodiments are not limited thereto. In this example, the network includes a one-hot encoding layer, one or more gated recurrent units (GRU) layers, a concatenation layer, and a sigmoid (predictive) layer. In some embodiments, the input identifier may be an alphanumeric string having a dynamic size (e.g., 5 to 325 characters, etc.) but not limited to any particular size. Each character is entered once, and a search is performed. The model may embed the characters into a vector form using the one-hot encoding layer, and then the vectors are sent to one or more GRU layers. There are sequences in the chemical names that are captured by the model. In this example, the model 400 includes a couple layers of GRU nodes which capture these chemical sequences, which is then passed to a CONCAT layer which combines the captured segments into a long sequence, which is then passed to a SIGMOID prediction layer which provides a respective prediction for each possible group assignment (e.g., several hundred groups, etc.) The output may be a probability, a one/zero, or the like.

It should be appreciated that the example of the architecture shown in FIG. 4 is just one example, and there are other architectures that could be used to solve the exact same problem. Other examples of algorithms would be convolution network before applying the GRU. Also, the model could be extended when the information in the database is extended in the future, and complexity needs to be added to the model.

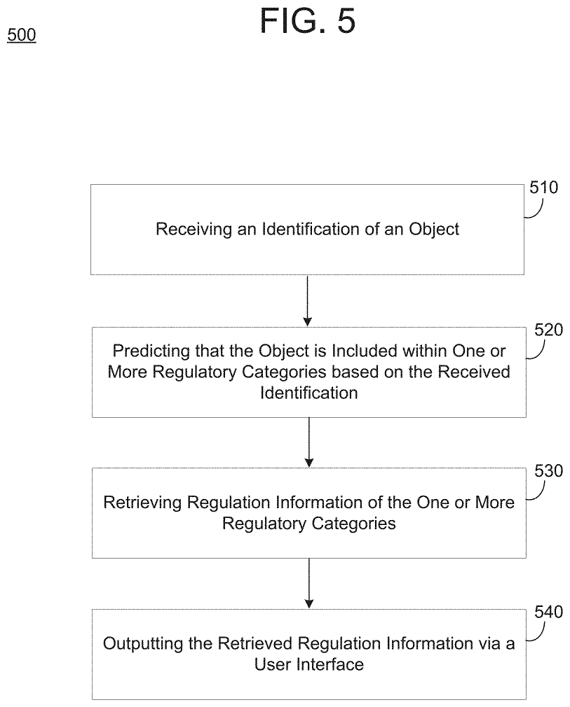

FIG. 5 illustrates a method 500 a method of assigning a product to one or more regulatory categories in accordance with an example embodiment. For example, the method 500 may be performed by a database node, a cloud platform, a web server, an on-premises server, a computing system (user device), a combination of devices/nodes, or the like. Referring to the example of FIG. 5, in 510, the method may include receiving an identifier of an object. Here, the object may be a product, an item, a good, or the like, and the identifier may be a trade name of an ingredient, a chemical ingredient/property, and the like. The identifier may include a string of alphanumeric characters in which letters and/or numbers are combined into a sequence.

In 520, the method may include predicting that the object is included within one or more regulatory categories via execution of a regulatory-based machine learning model (algorithm) that receives the identifier of the object as an input and classifies the object into the one or more regulatory categories. For example, the model may predict whether the object is included within each of a plurality of regulatory categories (groups) based on alphanumeric content within the identifier. A product may be included in one regulatory group, multiple regulatory groups, or no regulatory group.

In this example, the regulatory-based machine learning model may determine whether the object is included in a regulatory category based on a plurality of segments of characters detected within the alphanumeric identifier. In some embodiments, the regulatory-based machine learning model determines whether the object is included in the regulatory category based on a sequence of the detected segments. For example, the character “1” before the segment “tri” may be analyzed differently if the character “1” comes after the segment tri, etc. In some embodiments, the predicting may include simultaneously predicting whether the object is included in a plurality of different regulatory categories via execution of the regulatory-based machine learning algorithm.

In 530, the method may include retrieving regulation information about the one or more predicted regulatory categories for at least one jurisdiction associated with the object. For example, the regulatory information may be stored in a data store (e.g., data store 120 shown in FIG. 1), or the like. In 540, the method may include outputting the retrieved regulation information about the one or more predicted regulations for display via a user interface. According to various embodiments, each regulatory category from among the plurality of different regulatory categories may be paired with one or more regulations in one or more jurisdictions. Here, the outputting may include outputting the regulations that are paired with an assigned (predicted) regulatory category. In some embodiments, the predicting may further include determining a respective confidence value for each of the one or more predicted regulatory categories and outputting the confidence value on the user interface.

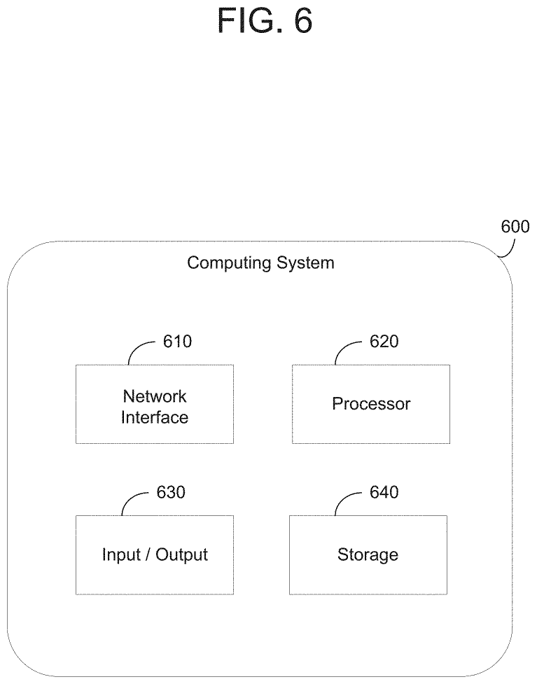

FIG. 6 illustrates a computing system 600 that may be used in any of the methods and processes described herein, in accordance with an example embodiment. For example, the computing system 600 may be a database node, a server, a cloud platform, or the like. In some embodiments, the computing system 600 may be distributed across multiple computing devices such as multiple database nodes. Referring to FIG. 6, the computing system 600 includes a network interface 610, a processor 620, an input/output 630, and a storage device 640 such as an in-memory storage, and the like. Although not shown in FIG. 6, the computing system 600 may also include or be electronically connected to other components such as a display, an input unit(s), a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The input/output 630 may include an interface, a port, a cable, a bus, a board, a wire, and the like, for inputting and outputting data to and from the computing system 600. For example, data may be output to an embedded display of the computing system 600, an externally connected display, a display connected to the cloud, another device, and the like. The network interface 610, the input/output 630, the storage 640, or a combination thereof, may interact with applications executing on other devices.

The storage device 640 is not limited to a particular storage device and may include any known memory device such as RAM, ROM, hard disk, and the like, and may or may not be included within a database system, a cloud environment, a web server, or the like. The storage 640 may store software modules or other instructions which can be executed by the processor 620 to perform the method shown in FIG. 5. According to various embodiments, the storage 640 may include a data store having a plurality of tables, partitions and sub-partitions. The storage 640 may be used to store database records, items, entries, and the like. For example, the storage 640 may include products and properties of the products that are stored therein including descriptive attributes of the products such as chemical compositions, chemical properties, characteristics, and the like.

According to various embodiments, the storage 640 may store instructions (code, application, executable, etc.) of a regulatory-based machine learning algorithm. The processor 640 may receive or otherwise detect an alphanumeric identifier of an object. The identifier may be input through a search bar, provided via a field of a user interface, or the like. The processor 640 may predict that the object is included within one or more regulatory categories via execution of the regulatory-based machine learning algorithm that receives the identifier of the object as an input and classifies the object into the one or more regulatory categories. For example, the processor 620 may execute the regulatory-based machine learning algorithm which receives the alphanumeric string as input and outputs a regulatory group assignment and regulation information associated with the assigned group. Furthermore, the processor 640 may retrieve regulation information about the one or more predicted regulatory categories for at least one jurisdiction associated with the object from the storage 640.

In some embodiments, the network interface 610 and/or the input/output 630 may output the retrieved regulation information about the one or more predicted regulations for display via a user interface. In some examples, the network interface 610 may be used to output the regulation information to a screen of a network connected device such as another computing system, a display, a television, or the like. As another example, the input/output 630 may output the regulatory information for display on an embedded or locally connected display monitor.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store a regulatory-based machine learning algorithm;
a processor configured to receive an alphanumeric identifier of an object, predict that the object is included within one or more regulatory categories via execution of the regulatory-based machine learning algorithm that receives the identifier of the object as an input and classifies the object into the one or more regulatory categories, and retrieve regulation information about the one or more predicted regulatory categories for at least one jurisdiction associated with the object; and
an interface configured to output the retrieved regulation information about the one or more predicted regulations for display via a user interface.

2. The computing system of claim 1, wherein the alphanumeric identifier comprises a description of one or more chemical attributes of the object.

3. The computing system of claim 1, wherein the alphanumeric identifier comprises an alphanumeric string including a combination of numbers and letters.

4. The computing system of claim 1, wherein, when executed by the processor, the regulatory-based machine learning algorithm determines whether the object is included in a regulatory category based on a plurality of segments of characters detected within the alphanumeric identifier.

5. The computing system of claim 4, wherein, when executed by the processor, the regulatory-based machine learning algorithm determines whether the object is included in the regulatory category based on a sequence of the detected segments.

6. The computing system of claim 1, wherein the processor is configured to simultaneously predict whether the object is included in a plurality of different regulatory categories via execution of the regulatory-based machine learning algorithm.

7. The computing system of claim 6, wherein each regulatory category from among the plurality of different regulatory categories is paired with one or more regulations in one or more jurisdictions.

8. The computing system of claim 1, wherein the processor is further configured to determine a respective confidence value for each of the one or more predicted regulatory categories of the object, and the outputting further comprises outputting respective confidence values.

9. A method comprising:
receiving an alphanumeric identifier of an object;
predicting that the object is included within one or more regulatory categories via execution of a regulatory-based machine learning algorithm that receives the identifier of the object as an input and classifies the object into the one or more regulatory categories;
retrieving regulation information about the one or more predicted regulatory categories for at least one jurisdiction associated with the object; and
outputting the retrieved regulation information about the one or more predicted regulations for display via a user interface.

10. The method of claim 9, wherein the alphanumeric identifier comprises a description of one or more chemical attributes of the object.

11. The method of claim 9, wherein the alphanumeric identifier comprises an alphanumeric string including a combination of numbers and letters.

12. The method of claim 9, wherein the regulatory-based machine learning algorithm determines whether the object is included in a regulatory category based on a plurality of segments of characters detected within the alphanumeric identifier.

13. The method of claim 12, wherein the regulatory-based machine learning algorithm determines whether the object is included in the regulatory category based on a sequence of the detected segments.

14. The method of claim 9, wherein the predicting comprises simultaneously predicting whether the object is included in a plurality of different regulatory categories via execution of the regulatory-based machine learning algorithm.

15. The method of claim 14, wherein each regulatory category from among the plurality of different regulatory categories is paired with one or more regulations in one or more jurisdictions.

16. The method of claim 9, wherein the predicting further comprises determining a respective confidence value for each of the one or more predicted regulatory categories of the object, and the outputting further comprises outputting respective confidence values.

17. A non-transitory computer readable medium comprising instructions which when executed by a processor cause a computer to perform a method comprising:
receiving an alphanumeric identifier of an object;
predicting that the object is included within one or more regulatory categories via execution of a regulatory-based machine learning algorithm that receives the identifier of the object as an input and classifies the object into the one or more regulatory categories;
retrieving regulation information about the one or more predicted regulatory categories for at least one jurisdiction associated with the object; and
outputting the retrieved regulation information about the one or more predicted regulations for display via a user interface.

18. The non-transitory computer readable medium of claim 17, wherein the alphanumeric identifier comprises a description of one or more chemical attributes of the object.

19. The non-transitory computer readable medium of claim 17, wherein the regulatory-based machine learning algorithm determines whether the object is included in a regulatory category based on a sequence of segment of characters detected within the alphanumeric identifier.

20. The non-transitory computer readable medium of claim 17, wherein the predicting comprises simultaneously predicting whether the object is included in a plurality of different regulatory categories via execution of the regulatory-based machine learning algorithm.
